(19) United States
(12) Patent Application Publication
(10) Pub. No.: US 2014/0315148 A1
(43) Pub. Date: Oct. 23, 2014

(54) DENTAL FORCEPS

(71) Applicants: Kim CHANG, Calgary (CA); Jun Suk SONG, Bayside, NY (US)

(72) Inventors: Kim CHANG, Calgary (CA); Jun Suk SONG, Bayside, NY (US)

(21) Appl. No.: 14/255,575

(22) Filed: Apr. 17, 2014

Related U.S. Application Data
(60) Provisional application No. 61/813,513, filed on Apr. 18, 2013.

(51) Int. Cl. A61C 3/16; A61C 3/14

(52) U.S. Cl. CPC A61C 3/162; A61C 3/14
USPC 433/159; 433/215

(57) ABSTRACT

Dental forceps include opposing gripping surfaces configured to grip a tooth or crown and a fulcrum pad adjacent the gripping surfaces. The forceps may act as a first class lever with the fulcrum pad to extract the tooth or crown when gripping the tooth or crown.

### CROSS REFERENCE TO RELATED APPLICATIONS

This application claims the priority benefit of U.S. Provisional Application No. 61/813,513 filed on Apr. 18, 2013 entitled Improved Dental Forceps, the contents of which are incorporated herein by reference.

### FIELD OF THE INVENTION

The present invention relates to an improved dental forceps tool.

### BACKGROUND TO THE INVENTION

Significant advances have been made in the last few decades in dental care and treatment. Not only are there a host of personal dental care appliances and cleaning agents, but significant advances have also been made in the general practice and general dentistry field. It has become a common practice to repair missing teeth by placing a root form dental implant into the bone and restoring a crown on top of it. The dental implant is placed into the bone surgically. The patient may wait several months depending on bone quality for osseointegration of the implant to occur. A prosthetic abutment is then connected to the implant fixture.

Prostheses may be attached to implants or implant abutments using screw retention or cementation. With the increased use of cementation, loosening of an abutment screw is a challenging complication of cement-retained, implant-supported prosthetic restorations. Often, the abutment screw becomes loose from the implant body, while the crown remains cemented to the abutment. In such situations, separating the cemented crown from the underlying abutment or locating the abutment-screw access for removal of the restoration is a difficult task.

Dental forceps are known and commonly used to remove a crown. All existing forceps designs require a combination of at least two forces to remove a crown. A gripping force applied by opposing jaws is combined with a pulling or withdrawing force subsequently applied to the tool.

Therefore, it would be desirable to have a dental forceps that would be available for various dental applications. A number of other characteristics, advantages, and or associated novel features of the present invention, will be apparent in view of the description, which follows.

### SUMMARY OF THE INVENTION

In one aspect, the invention comprises an improved dental forceps, which uses simple mechanical advantage by employing first-class lever mechanics, for extracting a first tooth or crown positioned adjacent or nearby a second tooth. In one embodiment, the dental forceps comprise:

(a) a pair of forcep arms each comprising a handle end and a gripping end, the arms pivotally connected at a point intermediate their ends;

(b) each gripping end comprising a gripping surface, configured such that the two gripping surfaces are opposing and the distance between the gripping surfaces may be varied by pivotally adjusting the handle ends; and

(c) a fulcrum pad intermediate the gripping end and the handle end;

wherein, when the fulcrum pad rests on the second tooth and the gripping surfaces are urged together, a downward force applied to the handle end of the forceps arms results in the forcep arms pivoting about an axis and an upward force at the gripping end, substantially perpendicular to a horizontal compression force applied by the gripping surfaces to the first tooth or crown between the gripping surfaces.

In one embodiment, the fulcrum pad is positioned such that the horizontal gripping force applied by the gripping surfaces to the first tooth or crown is substantially parallel to the axis about which the forcep arms pivot.

In one embodiment, the dental forceps further comprise a first intermediate portion depending downwards from the forceps arms and a second intermediate portion extending outward from the first intermediate portion to the gripping end. The angle between the forceps arms and the first intermediate portion may be about 80° to about 110°, and more particularly about 100°, and the angle between the first intermediate portion and the second intermediate portion may be about 110° to about 130°, and more particularly about 120°. The second intermediate portion may comprise gripping arms which depend downwardly and terminate with the gripping surfaces. The fulcrum pad may be disposed on either the first intermediate portion or the second intermediate portion.

In one embodiment, the fulcrum pad is disposed between the intermediate point and the gripping surfaces.

In one embodiment, the fulcrum pad comprises a resilient material, which may comprise an elastomer or a rubber.

In one embodiment, the gripping surfaces comprise a resilient material, which comprise an elastomer or a rubber. The resilient material may further comprise a textured or frictional material having a higher coefficient of friction than the remaining surface of the forcep arms. The frictional material may comprise emery powder.

In another aspect, the invention may comprise a method of extracting a tooth or removing a crown, comprising the steps of:

(a) gripping the tooth or crown with a forceps having opposing gripping surfaces, a handle end, and a fulcrum pad between the gripping surfaces and the handle end;

(b) using the forceps as a first class lever by supporting the fulcrum pad and applying a force to a handle end to create an extraction/removal force at the gripping surfaces.

In another aspect, the invention may comprise a dental forceps comprising opposing gripping surfaces configured to grip a tooth or crown, and a fulcrum pad disposed adjacent the gripping surfaces and configured such that the forceps may act as a first class lever to extract the tooth or crown when gripping the tooth or crown.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a bottom plan view of one embodiment of the dental forceps of the present invention.

FIG. 2 is a bottom perspective view of the gripping ends of the embodiment of the dental forceps shown in FIG. 1.

FIG. 3 shows a top perspective view of another embodiment of the dental forceps of the present invention.

### DETAILED DESCRIPTION OF PREFERRED EMBODIMENTS

The present invention relates to improved dental forceps. Any term or expression not expressly defined herein shall have its commonly accepted definition understood by those skilled in the art.

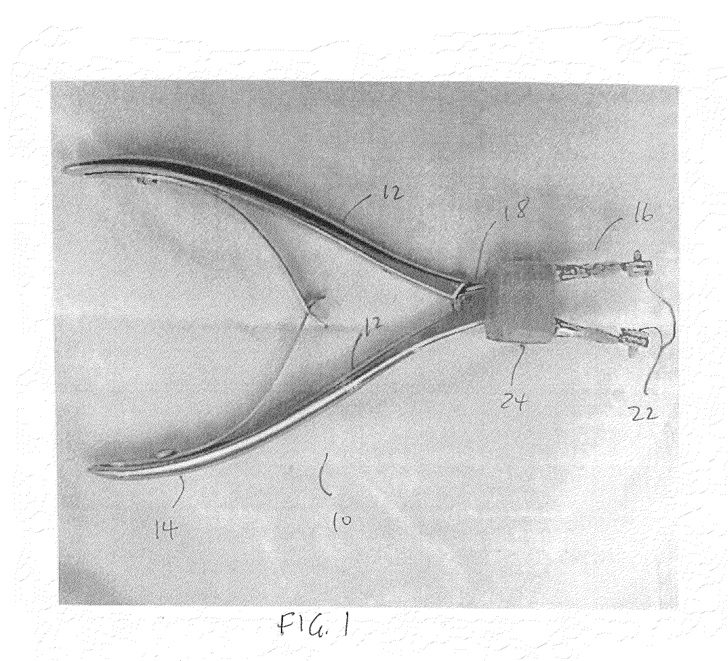

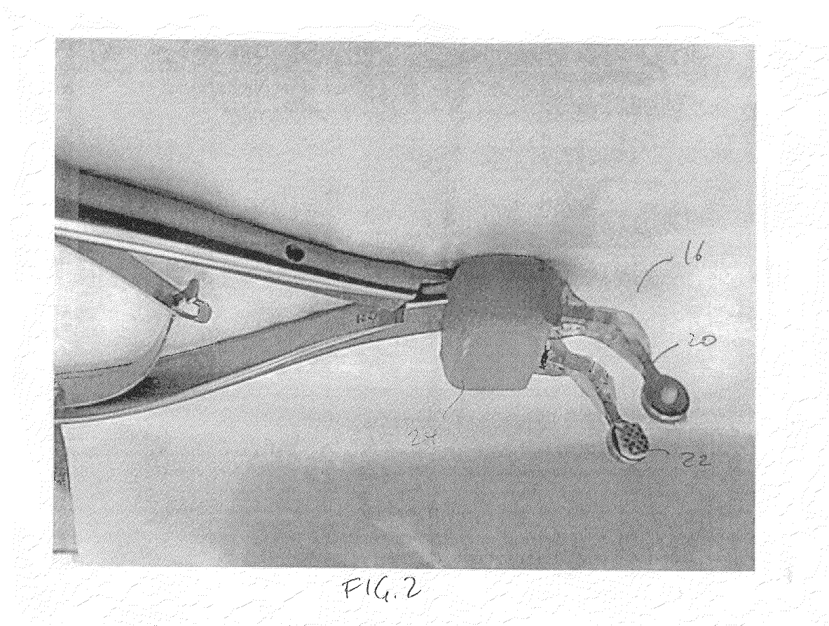

In one embodiment, as shown in FIGS. 1 and 2, the forceps (10) of the invention comprises a pair of forcep arms (12) each comprising a handle end (14) and a gripping end (16). The arms (12) are pivotally connected at a point (18) intermediate their ends (14, 16).

Referring to FIG. 2, each gripping end (16) comprises a gripping arm (20), such that the forceps (10) comprises two opposing gripping surfaces (22). The distance between the gripping surfaces (22) may be varied by pivotally adjusting the forcep arms (12). In one embodiment, as shown in FIG. 1, the gripping surfaces (22) may be biased away from each other by spring members between the handle end (14). A fulcrum pad (24) is provided intermediate the gripping end (16) and the handle end (14).

Although the forceps (10) may be used in any orientation, the description of the forceps (10) herein will make reference to a handle plane as being a horizontal plane, with upward and downward directions being substantially perpendicular to the handle plane. Thus, with the forceps (10) being oriented horizontally, the forcep arms (12) are substantially aligned with a handle plane. In one embodiment, the forceps arms (12) may be curved in the handle plane, viewed from above or below, as is shown in FIG. 1, and the handle ends (14) are preferably straight when viewed from the side, along the handle plane. At the gripping end (16), the gripping arms (20) bend downwardly from the handle plane.

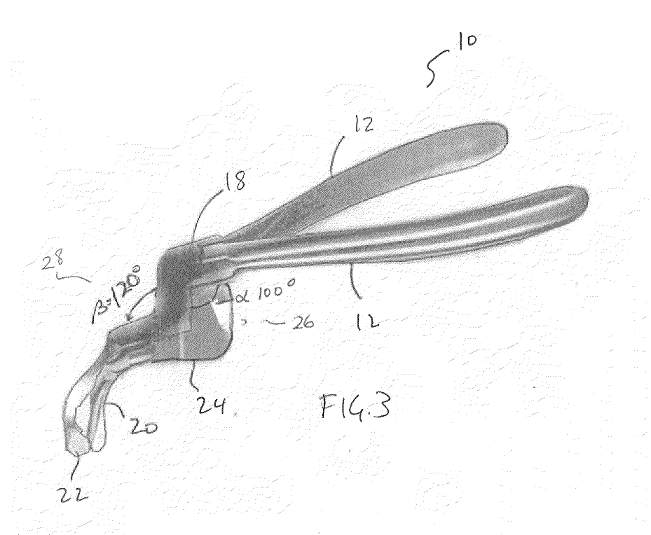

In one embodiment, as shown in FIG. 3, the forceps (10) may comprise a first intermediate portion (26) which is angled downward from the handle plane by angle alpha (α), and a second intermediate portion (28) which is angled from the first intermediate portion (26) by angle beta (β). In one embodiment, angle alpha may be about 80° to about 110°, preferably about 100°, while angle beta may be about 110° to about 130°, preferably about 120°. The fulcrum pad (24) may be disposed on the first (26) or second (28) intermediate portions.

In use, a user may manipulate the forceps (10) such that the gripping surfaces (22) are positioned immediately adjacent and on opposite sides of the tooth or crown to be extracted, and the fulcrum pad (24) rests on and is supported by the top of an adjacent or nearby tooth. The user then squeezes the handle ends (14) of the forceps arms (12) to grip the tooth or crown between the gripping surfaces (22) with a desired level of force, while simultaneously applying a downward force applied to the handle end (14) of the forceps (10). The forceps (10) thus pivots about an axis substantially parallel to the handle plane and acts as a first class lever on the fulcrum pad (24), resulting in an upward extraction/removal force at the gripping end (16) and the gripping surfaces (22). The gripping compression force created between the opposing gripping surfaces (22) by the forceps arms (12) is parallel to the handle plane, substantially parallel to the pivot axis, and perpendicular to the levered upward extraction/removal force created by the forceps (10).

The pivot connection (18) between the forcep arms (12) may be closer to the gripping end (16) than the handle end (14), permitting significant leverage to multiply the gripping force. In one embodiment, the fulcrum pad (24) is positioned between the pivot connection (18) and the gripping surfaces (22), again permitting leveraged force at the gripping end (16). In one embodiment, as shown in FIGS. 1 to 3, the fulcrum pad (24) is positioned adjacent the gripping surfaces (22), so as to maximize the leveraged extraction/removal force at the gripping end (16).

The fulcrum pad (24) may comprise a resilient material, such as a relatively firm elastomeric or rubber material, which preferably provides a relatively firm surface to act as a fulcrum, while not damaging the teeth it may rest on. It is preferred that the fulcrum pad (24) resist slipping, either by comprising or incorporating a non-slip material, or by offering a resilient surface which conforms to the irregular surface of the tooth or teeth it rests on, or both.

The gripping surfaces (22) may be configured to grip a tooth or a crown. In one embodiment as shown in FIGS. 1 and 2, the gripping surfaces are shaped and sized to match the sides of a typical human tooth. The gripping surfaces (22) may be comprised of a resilient material, such as an elastomer or rubber pad, and may also comprise a textured or frictional material (i.e., a material having a higher coefficient of friction than the remaining surface of the forcep arms (12)) to assist in gripping the tooth or crown to be removed. The frictional material may comprise an abrasive powder, such as emery powder.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

What is claimed is:

1. Dental forceps for extracting a first tooth or crown positioned adjacent or nearby a second tooth, the dental forceps comprising:
(a) a pair of forcep arms each comprising a handle end and a gripping end, the arms pivotally connected at a point intermediate their ends;
(b) each gripping end comprising a gripping surface, configured such that the two gripping surfaces are opposing and the distance between the gripping surfaces may be varied by pivotally adjusting the handle ends; and
(c) a fulcrum pad intermediate the gripping end and the handle end;
wherein, when the fulcrum pad rests on the second tooth and the gripping surfaces are urged together, a downward force applied to the handle end of the forceps arms results in the forcep arms pivoting about an axis and an upward force at the gripping end, substantially perpendicular to a horizontal compression force applied by the gripping surfaces to the first tooth or crown between the gripping surfaces.

2. The dental forceps of claim 1 wherein the fulcrum pad is positioned such that the horizontal gripping force applied by the gripping surfaces to the first tooth or crown is substantially parallel to the axis about which the forcep arms pivot.

3. The dental forceps of claim 1 further comprising a first intermediate portion depending downwards from the forceps arms and a second intermediate portion extending outward from the first intermediate portion to the gripping end.

4. The dental forceps of claim 3 wherein the angle between the forceps arms and the first intermediate portion is about 80° to about 110° and the angle between the first intermediate portion and the second intermediate portion is about 110° to about 130°.

5. The dental forceps of claim 4 wherein the angle between the forceps arms and the first intermediate portion is about 100° and the angle between the first intermediate portion and the second intermediate portion is about 120°.

6. The dental forceps of claim 3 wherein the second intermediate portion comprises gripping arms which depend downwardly and terminate with the gripping surfaces.

7. The dental forceps of claim 6 wherein the fulcrum pad is disposed on either the first intermediate portion or the second intermediate portion.

8. The dental forceps of claim 1 wherein the fulcrum pad is disposed between the intermediate point and the gripping surfaces.

9. The dental forceps of claim 1 wherein the fulcrum pad comprises a resilient material.

10. The dental forceps of claim 9 wherein the resilient material comprises an elastomer or a rubber.

11. The dental forceps of claim 1 wherein the gripping surfaces comprises a resilient material.

12. The dental forceps of claim 11 wherein the resilient material comprises an elastomer or a rubber.

13. The dental forceps of claim 11 wherein the resilient material further comprises a textured or frictional material having a higher coefficient of friction than the remaining surface of the forcep arms.

14. The dental forceps of claim 13 wherein the frictional material comprises emery powder.

15. A method of extracting a tooth or removing a crown, comprising the steps of:
(a) gripping the tooth or crown with a forceps having opposing gripping surfaces, a handle end, and a fulcrum pad between the gripping surfaces and the handle end;
(b) using the forceps as a first class lever by supporting the fulcrum pad and applying a force to the handle end to create an extraction/removal force at the gripping surfaces.

16. A dental forceps comprising opposing gripping surfaces configured to grip a tooth or crown, and a fulcrum pad disposed adjacent the gripping surfaces and configured such that the forceps may act as a first class lever to extract the tooth or crown when gripping the tooth or crown.
